(19) United States
(12) Patent Application Publication
(10) Pub. No.: US 2005/0147461 A1
(43) Pub. Date: Jul. 7, 2005

(54) Dispensing brush

(76) Inventor: J. Scott Glover, Irving, TX (US)

Correspondence Address: IP SECTION;GARDERE WYNNE SEWELL LLP, 3000 THANKSGIVING TOWER, 1601 ELM STREET, SUITE 3000, DALLAS, TX, 75201, US

(21) Appl. No.: 11/071,855

(22) Filed: Mar. 3, 2005

Related U.S. Application Data
(63) Continuation-in-part of application No. 10/947,006, filed on Sep. 21, 2004.
(60) Provisional application No. 60/504,802, filed on Sep. 22, 2003.

(51) Int. Cl. B43K 5/06; A46B 11/04

(52) U.S. Cl. 401/279; 401/278; 401/188 R

(57) ABSTRACT

A dispensing toothbrush includes a toothpaste reservoir chamber formed in a handle having a paste advancing piston disposed therein. The handle may be closed at one end by a floss dispenser. The handle is connected to a brush head and adapter assembly which includes a manual actuator which is disposed for sliding movement in the adapter to displace a plunger which reduces the volume of a chamber in the plunger to discharge paste into a feed tube. The suction plunger may be biased by a spring or include an elastic memory sufficient to restore the plunger to its original position whereby paste is drawn from the paste reservoir into the plunger chamber. A rubber cover is disposed over the actuator and is also sealingly engageable with a removable, vented brush cover.

### CROSS REFERENCE TO RELATED APPLICATIONS

This application is a continuation-in-part of copending application Ser. No. 10/947,006, filed Sep. 21, 2004, which claims the benefit of provisional patent application No. 60/504,802, filed Sep. 22, 2003.

### BACKGROUND OF THE INVENTION

U.S. Pat. No. 5,158,383 (Glover et al.) discloses a paste dispensing brush which includes a stem having a tapered bore therein, and a tapered piston disposed within the tapered bore and having an outer contour which at least substantially corresponds to the contour of the bore such that the tapered piston will nest in the tapered bore.

U.S. Pat. No. 6,039,489 (Harman et al.) discloses an arrangement in a dispensing brush wherein a spring is associated with an entire assembly, occupying the entire width of the cartridge. This patent also discloses a brush aperture blocking member which divides a stem bore into a dry portion and a pumping chamber.

Several problems have persisted in the art of paste dispensing toothbrushes and the like. There is a need for a paste dispensing toothbrush which reliably dispenses paste when the brush dispensing mechanism is actuated and which will reliably dispense most of the paste in the paste reservoir. This problem is somewhat related to the problem of properly filling the paste reservoir at the time of manufacture of the brush to eliminate any air pockets or voids in the paste reservoir chamber. Still further, it is important that the paste dispensing orifice in the brush head be completely closed except when paste is being dispensed onto the brush to prevent contamination of paste stored in the paste feed tube or straw. Still further, there has been a need to provide a paste dispensing brush which may be rested on its side without contact of the brush bristles with the surface on which the brush is residing. These and other problems in the art of paste dispensing brushes have been overcome by the inventive features of the paste dispensing brush of the present invention.

### SUMMARY OF THE INVENTION

The present invention provides a combination brush and dispenser for a cleaning compound or other flowable material, in particular a toothbrush combined with a toothpaste and floss dispenser, so as to provide a complete oral care system that can be carried and used anywhere. This “all-in-tone” device allows for oral care convenience at home, at work and while traveling.

The present invention also comprises a quality soft bristle brush head, a 30-60 day usage paste reservoir and a floss dispenser with a similar duration supply of dental floss. Moreover, the dispensing brush may be adapted to use a replacement paste cartridge. The brush is preferably provided with a transparent brush head cover that includes vent ports for crossflow venting to allow the brush to dry faster after use.

The brush of the present invention includes an upper assembly that includes a transparent head cover, a paste dispensing plunger actuator and button, a hollow tubular suction plunger, a paste feed tube and a support or adapter, which can be threaded or snap-locked into engagement with a lower assembly including a handle part. The plunger may be actuated by a spring or be provided with an elastic memory of sufficient strength to eliminate the spring. The lower brush assembly may include an o-ring seal, a transparent paste reservoir and handle, a piston disposed in the reservoir, an optional metal cleat, a base cap with a floss dispensing spool and cutter and a bottom flip type cover.

The present invention may be operated by depressing the plunger actuating button which depresses the suction plunger and reduces the volume of a paste storage chamber in the plunger to discharge paste therefrom, and through a feed tube for deposit on the brush bristles. When the button is released a pressure differential draws paste from the paste reservoir past a check valve and into the plunger storage chamber. Once the plunger actuator button is released the plunger moves the feed tube to seal off an orifice in the brush head from backwash contaminates and prevents paste in the feed tube from drying up. As paste is removed from the reservoir, the piston and metal cleat move in the reservoir chamber creating a solid platform for the paste to push against allowing the process described above to be repeated. The floss dispenser provides for dental floss to be pulled over a cutter and then easily removed for use. A flip open type cap protects the floss from contamination.

The combination of the suction plunger and the paste feed tube provide positive displacement of paste and to draw paste from the paste reservoir while differential pressure moves the piston and the metal cleat, if provided. Moreover, the paste reservoir and handle may be fully replaceable, whereby an o-ring provides a seal at a connection between the lower assembly and upper assembly.

At least one embodiment of the toothpaste dispensing toothbrush according to the present invention includes a floss dispenser assembly and a flip open type cap. The floss dispenser assembly houses a floss storage and dispensing spool and a floss cutter. The dispensing brush includes a brush head having a hollow neck, which allows the feed tube to travel therein. The somewhat teardrop shaped brush head includes an orifice, allowing paste to be extruded from a feed tube onto the bristles. The bristle pattern is designed to allow the paste to flow upward to the top of the bristles. The depth and width of a connecting sleeve type adapter provides adequate strength at a pressure point between the upper and lower assemblies. A waterproof silicone or isoprene polymer rubber cover may be molded onto the base of the neck and upper assembly to prevent water, bacteria and or paste from leaking into or out of the actuator. The membrane-like cover material also acts to grip the head cover in a secure “locked” position when not in use. The brush bristles are trimmed to and contoured to naturally cradle the teeth, providing a leading cleaning edge on the front end and a sweeping action on the tail.

Further in accordance with the invention, the paste reservoir and brush handle may have a slight conical shape of the reservoir chamber bore thereby allowing the piston to travel easily in a paste dispensing direction while resisting movement in the opposite direction.

In accordance with another aspect of the present invention, a dispensing brush is provided which includes a resilient plunger having an elastic memory which restores the plunger to a position to draw paste from a reservoir whereby, upon a successive actuation of the plunger the paste is discharged into the feed tube as plunger volume is decreased. The paste reservoir is configured to provide a closeable vent port in a piston disposed in the reservoir chamber which provides for an improved method of filling the reservoir without creating a void in the reservoir chamber. Still further, the reservoir is provided with a viewing port and indicia to indicate the amount of paste remaining in the reservoir chamber.

The present invention still further provides a dispensing brush with a paste reservoir in the brush handle which is configured such that, when the brush is resting on its side on a surface, the brush may roll without the brush bristles coming into contact with the surface, thereby further preserving the hygienic qualities of the brush.

Those skilled in the art will further appreciate the above-mentioned advantages and superior features of the invention, together with other important aspects thereof upon reading the detailed description which follows in conjunction with the drawings.

### BRIEF DESCRIPTION OF THE DRAWINGS

FIG. 1 is a side elevation of a dispensing toothbrush according to the present invention;

FIG. 2 is a section view of the dispensing toothbrush of FIG. 1 taken along line 2-2 of FIG. 1;

FIG. 3 is an exploded perspective view of the dispensing toothbrush of FIG. 1;

FIG. 4 is a bottom end view showing a floss cutter of the dispensing toothbrush of FIG. 1;

FIG. 5 is an exploded side elevation view of one alternate embodiment of a dispensing toothbrush according to the present invention;

FIG. 6a is a side elevation of a reservoir and handle for the dispensing toothbrush of FIG. 5;

FIG. 6b is a top plan view of the reservoir handle of FIG. 6a;

FIG. 7 is a section view taken along the line 7-7 of FIG. 6a;

FIG. 8 is a front elevation view of the brush head of the dispensing toothbrush of FIG. 5;

FIG. 9 is a section view taken along the line 9-9 of FIG. 8,

FIG. 10 is a perspective view of a plunger button and actuator of the dispensing toothbrush of FIG. 5;

FIG. 11 is a perspective view of a cover for the plunger button of FIG. 10;

FIG. 12 is a top perspective view of a piston for the dispensing toothbrush of FIG. 5;

FIG. 13 is a bottom perspective view of the piston of FIG. 12;

FIG. 14 is an elevation, partially sectioned, of a suction plunger for the dispensing toothbrush of FIGS. 5 and 19;

FIG. 15 is a perspective view of the suction plunger of FIG. 14;

FIG. 16 is an exploded perspective view of a floss dispenser for the dispensing toothbrush of the invention;

FIG. 17 is a perspective view of the floss dispenser of FIG. 16;

FIG. 18 is another perspective view of the floss dispenser;

FIG. 19 is a longitudinal central section view of another embodiment of a dispensing brush of the invention; and

FIG. 20 is a detail section view on a larger scale of the suction plunger and surrounding parts for the brush embodiment of FIG. 19.

### DETAILED DESCRIPTION OF THE PREFERRED EMBODIMENTS

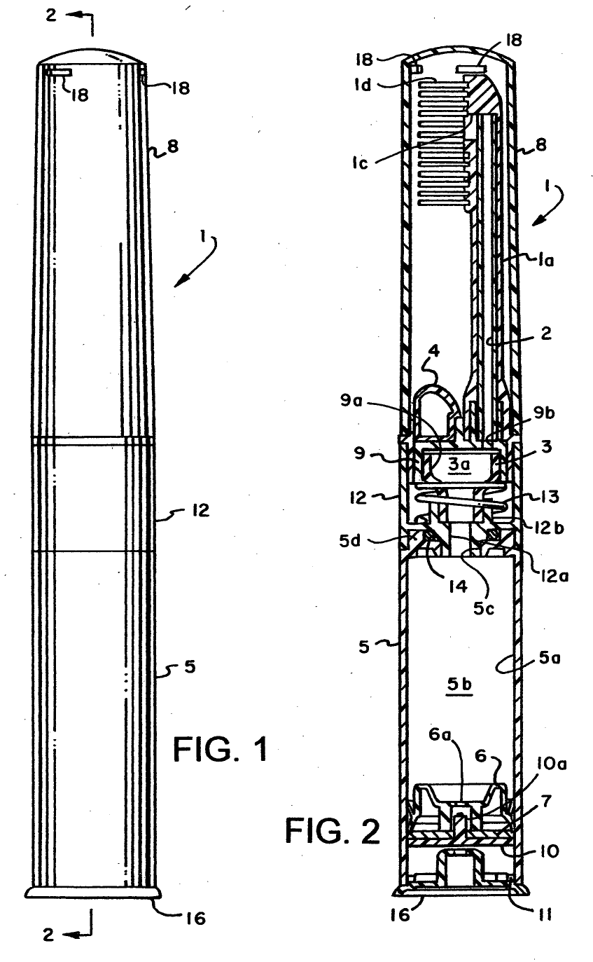

Referring to FIGS. 1 through 3, one preferred embodiment of a dispensing brush 1 includes an upper assembly that comprises a transparent tubular head cover 8, a brush head and neck 1a, a plunger button 4, a suction plunger 3, a coil return spring 13, a feed tube 2, a cylindrical actuator 9, and a tubular adapter 12, which can be threaded or a snap-lock adapter. The so-called lower assembly of brush 1 comprises an o-ring 14 supported on a transparent cylindrical tubular paste reservoir and handle 5, a piston 6, a pronged metal cleat 7, a disc shaped piston cover 10, and a base or cap with floss storage spool post and cutter assembly 11.

Piston 6 is slidable in a generally cylindrical bore 5a of handle 5, FIG. 2, and which defines a reservoir chamber 5b. Handle 5 includes a transverse wall 5d defining an opening 5c which opens to chamber 5b. Reservoir chamber 5b is in communication with a chamber 3a of suction plunger 3 by way of a passage 12a in adapter 12. Suction plunger 3 is nested in a bore defined by a generally cylindrical upward facing projection 12b of adapter 12. The upper end of suction plunger 3 is also disposed in a bore 9a of actuator 9. Piston 6 includes a port 6a which, in assembly with the cleat 7 and cover 10, is closed by a central post part 10a of cover 10.

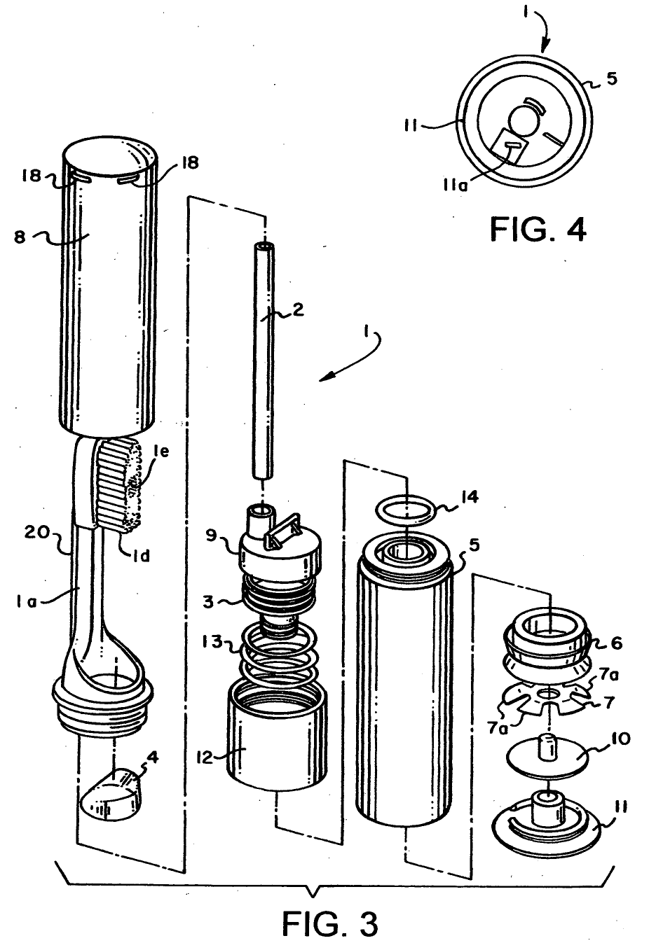

With the brush 1 completely assembled by connecting the upper brush assembly to the lower assembly by connection of adapter 12 to handle 5, and with reservoir chamber 5b completely full of toothpaste, such paste may be dispensed from interior chamber 3a of suction plunger 3 upon actuation of plunger button 4 by depressing this button to move actuator 9 downwardly, causing the resilient suction plunger 3 to be displaced and the volume of chamber 3a reduced whereby paste will flow upwardly through a port 9b into the interior of feed tube 2 which moves downward with actuator 9. Paste is dispensed through a passage or orifice 1c in brush head 1a, through a passage 1e, FIG. 3, between columns of bristles 1d and onto bristles 1d, FIG. 2. Once the plunger button 4 is released, spring 13 pushes actuator 9 upwardly moving feed tube 2 also upwardly so as to seal off communication between the feed tube and orifice 1c. As paste is removed from chamber 5b, upon successive actuations of the plunger button 4 and actuator 9, differential pressure will cause piston 6 to advance toward wall 5d. Prongs 7a, FIG. 3, of metal cleat 7 forcibly engage the bore wall 5a of handle 5 to allow the piston 6 to advance toward wall 5d but to prevent movement in the opposite direction. Moreover, handle 5, including the reservoir of paste, may be fully replaceable by disconnecting this member from the adapter 12, since a fluid tight seal is provided at o-ring 14. Depending on the embodiment of the invention to be provided, the adapter 12 may be permanently secured to handle 5, threadedly engaged with the handle or snap fitted to the handle 5 by way of a suitable interference fit and/or a locking pin between these parts.

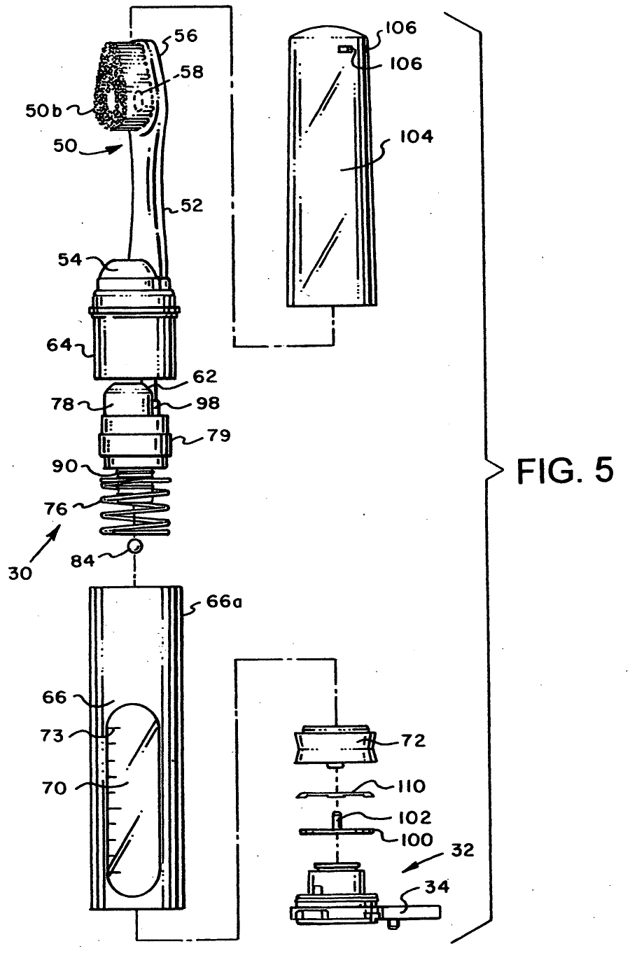

The floss dispenser 11 included in handle 5 allows floss to be pulled from the dispenser and across a cutter 11a, FIG. 4, then easily removed for use. A bottom flip open and closed type cap 16, FIG. 5, protects the floss from outside elements. The combination of suction plunger 3 and feed tube 2 provide a positive displacement action to pull paste from paste reservoir chamber 5b while advancing piston 6 and metal cleat 7. The brush 1 includes a head cover 8 that is preferably transparent, but may be translucent or at least partially opaque. Cover 8 includes plural spaced apart vents 18 providing for cross circulation of ambient air to allow the brush bristles, in particular, to dry faster after use.

In one respect, the present invention is a combination toothbrush, toothpaste reservoir and floss dispenser so as to provide a complete oral care system that can be carried and used anywhere. This “all-in-one” feature allows for oral care convenience at home, at the workplace and while traveling. Another aspect of the invention is the provision of a molded ridge 20, FIG. 3, extending along the back of brush head la and which functions as a tongue scraper.

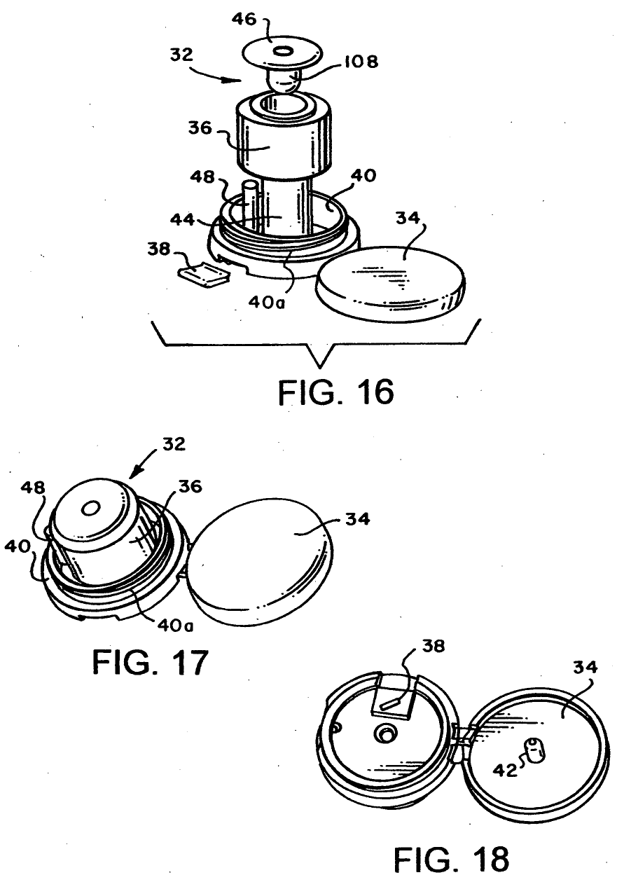

Referring now to FIG. 5, and particularly FIGS. 16 through 18, one alternate embodiment of a toothpaste dispensing toothbrush according to the present invention is referred to generally by reference numeral 30. Toothbrush 30 includes a floss dispenser assembly 32 which includes a flip open type cap 34. The floss dispenser assembly 32 houses a floss spool 36 and a floss cutter 38. The floss dispenser assembly 32 and cap 34 protect the floss from soiling, as well as allow the brush 30 to be stood upright. The floss dispenser assembly 32 includes a molded plastic cylindrical base 40 with integral hinged flip open cover or cap 34, which includes a center post type locking pin 42. A fixed hollow center post 44 is sized to receive a floss spool 36 and allows the spool to spin freely when pulling out floss. A floss spool locking cap 46 is installed in the hollow end of center post 44 to prevent the floss spool 36 from being removed or falling off while allowing the spool to spin freely upon activation of pulling the floss. A hollow floss guide post 48 is provided for threading the floss therethrough to ensure the floss is removed from the spool without tangling. A stainless steel cutter 38 is secured in the side of the base 40 under the cover 34 for cutting the desired amount of floss. The flatness of the flip type cover or cap 34 allows the brush 30 to be stood upright. A cylindrical rim 40a of the floss dispenser assembly 32 is operable to lock into the brush handle by being snapped in place. Rim 40a may comprise coarse screw threads also.

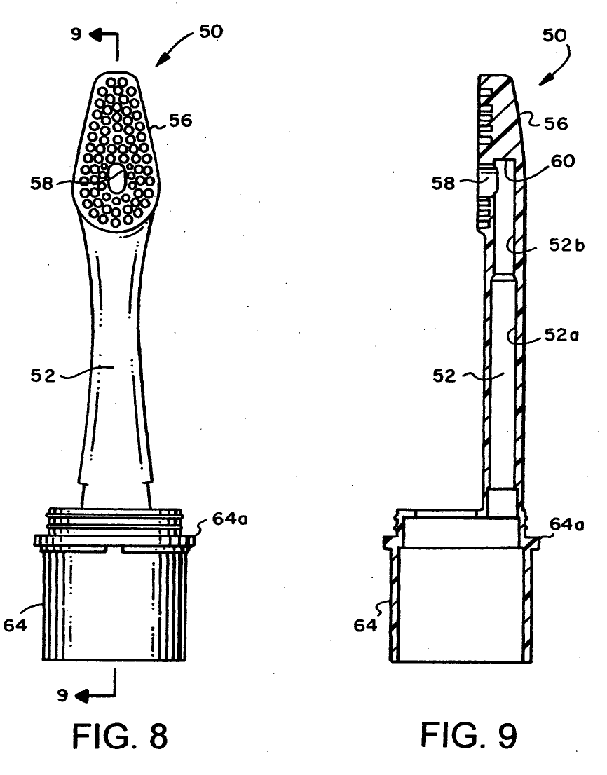

Referring to FIGS. 8, 9, 10 and 11, a molded plastic brush head 50 includes a hollow stem or neck 52 for a movable feed tube 62, FIG. 5, to be slidably disposed in passages 52a and 52b. Brush bristles have been omitted from FIGS. 8 and 9. Feed tube 62 functions substantially like feed tube 2. A silicone or KRATON brand polyisoprene rubber, somewhat membrane like button cover 54, see FIGS. 5 and 11, is provided for sealing water or paste leakage. Cover 54 includes a suitable opening 54b, FIG. 11, through which neck part 52 may project. Brush head stem or neck part 52 comprises an FDA grade molded plastic hollow member which allows the straight straw type feed tube 62 to slide between an open, paste dispensing, position and a closed position therewithin. The somewhat teardrop shaped brush head 56 includes an orifice 58 opening into passage 52b allowing paste to be extruded onto bristles 50b, FIG. 5. The bristle pattern is operable to allow the paste to flow to the distal ends of the bristles. A bore end wall 60, FIG. 9, is displaced from orifice 58 to act as a sealing point for feed tube 62.

A tubular sleeve adapter portion 64 of brush head 50 is adapted to be suitably connected to the tubular reservoir handle 66 by reception in bore 82, FIG. 7. The depth and width of adapter portion 64 provides adequate strength at this pressure point. Positioning and locking tabs, not shown, may be included on adapter portion 64 for ease of assembly to position and seal the connection to the handle 66 at upper end portion 66a. Waterproof membrane cover 54 may be molded or force fitted onto the base of the neck 52 at a flange 64a, FIGS. 8 and 9, to prevent water, bacteria and/or paste from leaking into or out of the plunger actuator and actuator button area. The membrane like cover 54 also acts to grip a brush head cover 104, FIG. 5, in a secured locking position. The bristles 50b are trimmed to and contoured to naturally cradle the teeth, providing a leading cleaning edge on the front end and a sweeping action on the tail.

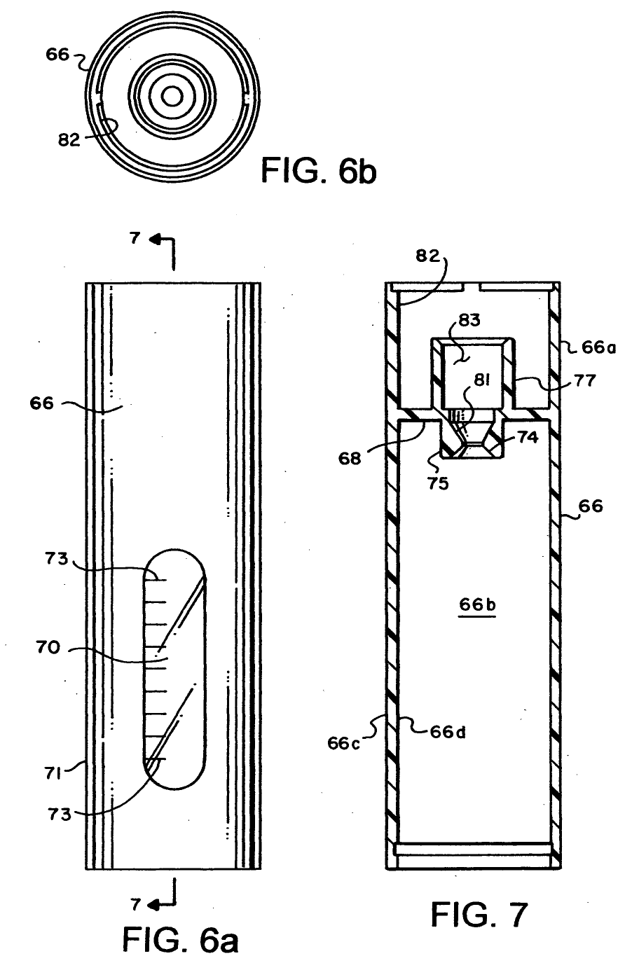

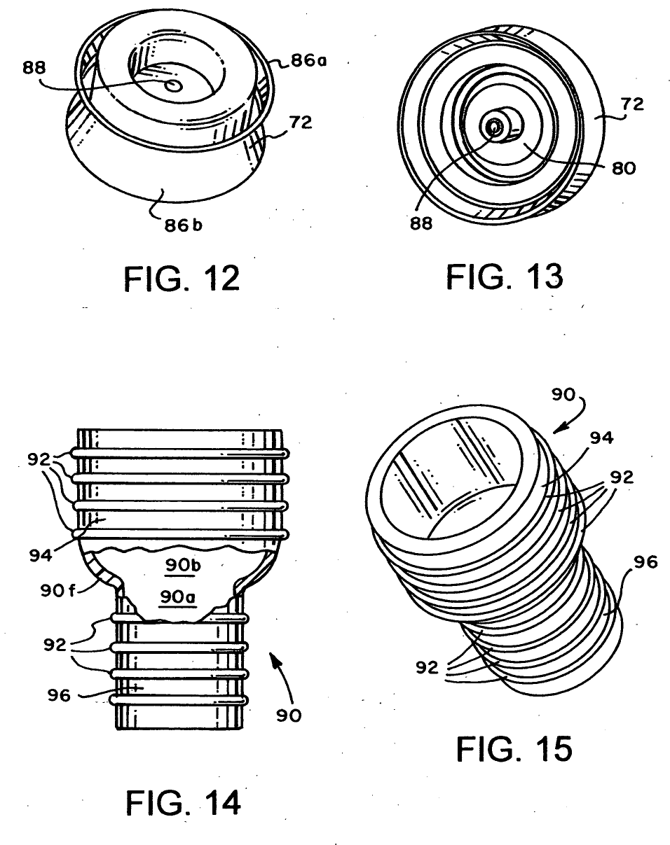

Referring also to FIGS. 6, 6a, 7, 12 and 13, paste reservoir handle 66 houses a paste supply in cylindrical chamber 66b. Handle 66 is easily gripped and held during use. A fixed platform or end wall 68 allows paste to transfer from reservoir handle 66 to upper assembly 50 through a port 74 formed on a boss 75, FIG. 7. The plastic reservoir handle 66 may include a transparent or translucent viewing window 70, FIG. 6a, to allow for monitoring the current paste level. With a transparent or translucent reservoir handle, viewing window 70 can be formed by a label or cover 71 suitably applied to the outside surface 66c of the reservoir handle, and wherein the label has a cutout for providing the viewing window 70. Alternatively, the window 70 may be provided with indicia 73 indicating the amount of paste remaining in the reservoir chamber. Indicia 73 may be molded in or otherwise applied to surface 66a of handle 66, if desired.

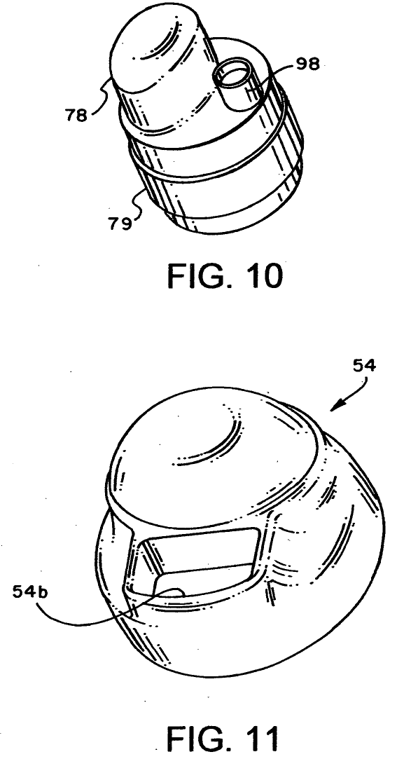

The interior wall 66d of reservoir handle 66 may be in a slight conical shape, becoming of slightly larger diameter from the bottom toward wall 68 and allowing a piston 72, FIG. 5, to travel easily in an upward direction and harder in a downward direction, FIG. 5. A tubular upward projecting boss 77 provides support for a suction plunger 90, FIG. 7 and FIGS. 14 and 15. A plunger button 78, FIGS. 5 and 10, is secured to a generally tubular actuator 79. The bore 82 receives the brush upper assembly at the adapter 64 and allows for adequate connection surface since this is a critical force pivot point. An area of about one-half or greater of the cylinder inside dimension is required. The orifice 74 also delimits a seat 81 for a check valve 84, FIG. 5, comprising a sphere made of plastic or other stable material which is inserted into a passage 83, FIG. 7, to control flow of paste.

Piston 72 travels from suction of paste, thereby providing a platform for the paste to push from, forcing the paste upward toward a chamber in plunger 90 and into feed tube 62. Piston 72 travels within the paste reservoir chamber 66b allowing for a constant positive position for the paste to push off of forcing the material forward. Piston 72 includes clean sweeping circumferential lips 86a and 86b, FIG. 12, which minimizes friction and drag on the wall 66d of the paste reservoir. A hole 88 is formed in the center of the piston 72, allowing air to exit during filling of chamber 66b. This bleeding of air out allows the piston 72 to engage with the paste material creating required displacement of paste at each plunger actuation. By depressing and release of button 54, suction plunger 90 moves to draw paste from the reservoir chamber 66b and pushing it into chambers 90a and 90b, FIG. 14, of plunger 90. During this action, plunger upper part 94, FIG. 14, telescopes somewhat over lower part 96. Parts 94 and 96 are joined by continuous compound curved wall 90f. Outer circumferential ribs 92 prevent paste leakage between the upper and lower assembly. Plunger 90 is provided of a resilient polymer material for stable memory and exacting tolerances. The lower chamber 90a may include a three prong molded crosspiece, not shown in FIGS. 14 or 15, to retain the check valve ball 84 for limited movement. When depressed the suction plunger 90 ejects the paste material stored in the chambers 90a and 90b and when released more material is drawn in these chambers.

Plunger actuator 79 fits over the upper part 94 of suction plunger 90 for exerting downward pressure activating the suction plunger then returning to the starting position ready for next actuation. A feed tube support post 98, FIG. 5, allows a connection point for feed tube 62. The plunger button provides primary actuation. By exerting downward pressure, the plunger button allows feed tube 62 which is connected to open the paste exiting orifice allowing paste to extrude onto the bristles, while simultaneously depressing the suction plunger. This plunger button is inserted into the sealed receiver in the brush head/neck upper assembly.

A piston air vent plug 100 includes a post 102 that fits into an air vent hole 88 located in the middle of piston 72. The stem or post 102 fits firmly into the air vent hole 72. This provides a seal in the air bleed hole used to allow air to exit the paste reservoir handle chamber 66b during filling. By inserting this piston cover air transfer is eliminated between the paste material and piston.

Pliable silicone or polyisoprene rubber button membrane or cover 54 is molded into the brush head upper assembly. By being pliable and formed of such rubber, this part provides a gripping surface for the thumb or forefinger for actuation. It also provides a positive grip for the head cover 104. Cover 54 also prevents water, bacteria or debris from entering the paste housing and is preferably red in color for identification of the actuation plunger button.

Straight feed tube 62 is suitably secured to the tubular post 98 of actuator 79, FIGS. 5 and 10, locking in place to become one with the actuator. When the plunger button 78 is activated the feed tube 62 travels from a closed position to an open position, returns to a closed position when released and seals off against end wall 60, FIG. 9, when in the closed position. The hollow straight feed tube 62 reduces friction on the walls of bores 52a and 52b. The inside tube diameter is such as to be of adequate size to allow free flow of the paste material.

Vented head cover 104 is similar to the cover 8 and protects bristled brush head 58 when not in use. Plural spaced apart vents 106, FIG. 5, allow for cross ventilation reducing brush drying time between uses. The head cover 104 may be transparent also to allow the plunger actuation button 54 to be seen and provides a seal from debris.

Ball check valve 84 acts as a paste reverse flow restrictor during operation. The small plastic sphere shaped valve 84 is inserted into the paste reservoir handle passage 83 for registration with seat 81. During operation, the check valve 84 is pushed downward sealing off flow at the conical orifice 74, providing restriction of paste flow from plunger chambers 90a and 90b to chamber 66b.

As mentioned herein, spool retaining disk 46, FIG. 16, acts to secure the floss spool 36 to the floss assembly 32. Disk 46 includes a locking cone plug or boss 108 for securing the floss spool to the floss assembly. This solid domed piece is inserted into the hollow stem 44 in the floss dispenser assembly 32 and is held in place by a snap or friction fit. The shoulder of disk 46 prevents the floss from sliding off the hollow stem and allows the floss spool to spin freely when in use.

A piston retaining cleat 110, FIG. 5, similar to cleat 7, and an optional part, is for use with varying viscosity of paste. This cleat 110 provides for a secure position of the piston 72 from any downward urging pressure, viewing FIG. 5. The cleat 110 is attached to the bottom of piston 72 prior to the piston cover 100 being installed. Cleat 110 is a light gauge three pronged stamped cleat, which provides a secure position for the piston once it travels upward. The cleat prongs dig into the reservoir bore wall 66d and prevent the piston 72 from traveling in reverse direction, thus providing a secure platform for the paste to extrude upward upon activation. As paste is ejected from reservoir chamber 66b the prongs release and travel with the piston 72 to its next location ready for use. Three (3) prongs verses four (4) or more additional prongs provide a stable platform and minimizes points of drag from additional prongs. Cleat 110 may be used with higher viscosity pastes and is not needed with low viscosity pastes or gels.

A plunger return spring 76, FIG. 5, preferably made of stainless steel, is disposed under and engageable with actuator 79 in a manner similar to the brush embodiment 1. This part helps in returning the actuator 79, suction plunger 90 and feed tube 98 to the closed or starting position. Conical shaped stainless steel spring 76 is located around part of suction plunger 90 also to force all related parts into a closed position. Spring 76 further provides a force closing off the paste discharge end of feed tube 98 creating a positive sealing off from leakage and or seepage and preventing contamination of paste in the feed tube by bacteria and/or debris. Depending on the thickness of the paste or other cleaning agent, suction plunger 90 can have enough “springiness” or elastic memory to provide the closing force, thus doing away with the necessity of a spring.

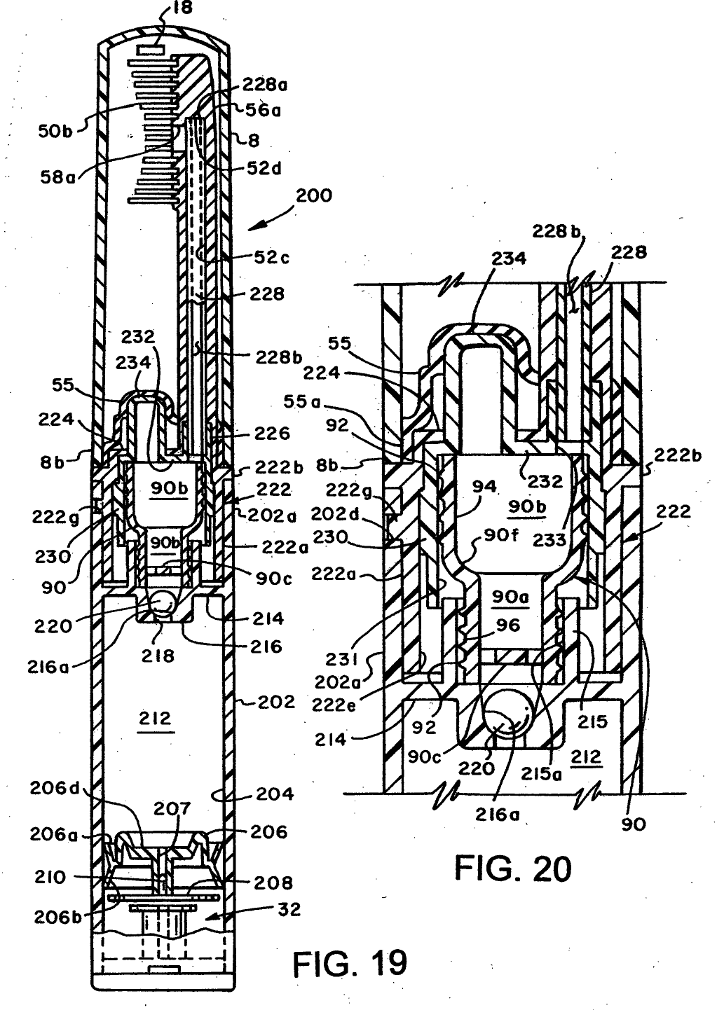

Referring now to FIG. 19, another embodiment of a dispensing brush in accordance with the invention is illustrated and generally designated by the numeral 200. The dispensing brush 200 is similar in many respects to the embodiments previously described. However, the dispensing brush 200 includes a generally cylindrical tubular handle 202 adapted to support at one end the floss dispensing assembly 32 within a generally cylindrical bore 204. Bore 204 is also operable to slidably receive a piston 206 having a central port 207 formed therein and opposed bore wall engaging seal lip portions 206a and 206b which are somewhat frusto-conical shaped and are integral with a hub part 206d of piston 206. Piston 206 is adapted to receive a disk shaped cap or cover 208 having a central stem part 210 which is insertable in port 207 for closing same.

Handle 202 defines a paste reservoir chamber 212 closed at one end by the piston 206 and at an opposite end by transverse integral wall part 214 of handle 202. A central boss 216 of wall 214 includes a port 218 formed therein which opens into passage or chamber 90a formed in suction plunger 90. Boss 216 also forms a frusto-conical seat 216a for a ball check valve 220 which is disposed for limited movement between the seat and a ball retainer 90c formed in the suction plunger 90. Retainer 90c has suitable openings formed therein to allow paste to flow through port 218 and to passage or chamber 90a and to enlarged passage or chamber 90b within suction plunger 90.

Brush handle 202 includes an upper cylindrical end part 202a for receiving a generally cylindrical adapter 222. Adapter 222 includes a cylindrical tubular wall portion 222a, delimited by a cylindrical flange 222b, and which is received within upward projecting extension or end part 202a of handle 202. Adapter 222 also includes an upper transverse wall 224, see FIG. 20 also, and an upward projecting tubular boss 226 which receives one end of a paste feed tube 228 therein and suitably secured thereto. Feed tube 228 projects slidingly in close fitting relationship within an elongated bore 52c of a modified brush head 56a. Feed tube receiving bore 52c terminates in an end wall 52d adjacent a port or orifice 58a. However, bore 52c extends beyond the edge of orifice 58a so that the distal end 228a of tube 228 seals against end wall 52d and prevents backflow of water or other contaminants into the bore or paste flow passage 228b of feed tube 228 and to prevent paste within the tube bore from drying or hardening.

Referring further to FIGS. 19 and 20, the dispensing brush 200 is further characterized by a plunger actuator 230 comprising a generally cylindrical sleeve-like member having a transverse end wall 232 above which projects an actuator “button” 234. Actuator 230 is slidably disposed in a bore 222e formed by cylindrical wall 222a and journals, in tight fitting relationship, the enlarged diameter upper end portion 94 of suction plunger 90. In like manner, an upwardly extending cylindrical tubular projection 215 extends from transverse wall 214 of handle 202 and receives reduced diameter lower end portion 96 of plunger 90. Still further, one end of the feed tube 228, including feed tube interior passage 228b, is in communication with the passage or chamber 90b of plunger 90 by way of a port 233 in actuator end wall 232, see FIG. 20 in particular.

Referring still further to FIGS. 19 and 20, actuator button 234 and the upper end of adapter 222, including flange 222b, are engaged with an integrated soft silicone or polyisoprene rubber membrane-like cover 55 which encapsulates the button 234, encircles the lower portion of the brush head 56a and is engaged with the adapter flange 222b. Adapter 222 may be integrally formed with the brush head 56a, as shown in FIGS. 19 and 20. The preferably red colored rubber cover 55 may be formed of a commercially available material such as KRATON brand rubber and the maximum diameter of the cover provides a circular seal surface 55a, FIG. 20, force fittingly engageable with the lower open end 86 of brush cover 8.

The operation of the dispensing brush 200 is similar to the other embodiments described hereinbefore. However, the suction plunger 90 for the embodiment 200 is formed of a resilient deformable polymer having an elastic memory which biases the suction plunger to assume the shape shown in FIGS. 19 and 20. Upon depressing the actuator button 234 the actuator 230 moves downwardly, viewing FIGS. 19 and 20, within the adapter bore 222e and the plunger 90 deforms in such a way that the enlarged diameter portion 94 essentially telescopes partially over the reduced diameter portion 94 at the juncture of these two portions formed by a curved continuous integral wall portion 90f, FIG. 20, thereby reducing the combined volume of chambers 90a and 90b and forcing toothpaste through the port 233 and the bore 228a of the tube 228. Of course, as the actuator button 234 is depressed the tube 228 moves away from the end wall 52d allowing paste to be ejected from the distal end 228a of the tube and into and through orifice 58a onto brush bristles 50b in a manner as previously described. Thanks to the provision of the plural sealing ribs 92 on the portions 94 and 96 of the plunger 90, the plunger is sealingly engaged with the cylindrical wall defining bore 231 and with the bore wall 215a.

As the actuator 230 moves downwardly, viewing FIGS. 19 and 20, the ball check valve 220 will move into engagement with its seat 216a to prevent paste from backflowing into reservoir chamber 212. When the actuator button 234 is released, the elastic memory of the plunger 90 will restore the actuator 230 and plunger to the position shown in FIGS. 19 and 20 increasing the volume of the chambers 90a and 90b. Differential pressure acting on piston 206 will force additional paste into the chambers 90a and 90b by unseating ball check valve 220 and allowing paste to flow into the interior of the plunger from chamber 212. Of course, the piston 206 will advance within chamber 212 to reduce the volume of the chamber by the amount of paste discharged into the chambers 90a and 90b. Moreover, when the actuator button 234 is released and the actuator 230 is restored to the positions shown in FIGS. 19 and 20, the feed tube 228 will also move upward in the bore 52c into engagement with the end wall 52d sealing off communication between the orifice 58a and the interior of the feed tube.

Referring further to FIG. 19, the configuration of the bristles 50b for the brush head 56a is also advantageous. As mentioned previously, the bristles may be configured to somewhat cradle a tooth while brushing action is occurring and at the same time present an array of bristles which will accomplish good cleaning action. Viewing FIG. 19, the bristles disposed at the distal end of head 56a are progressively shorter along a somewhat convex curved profile which becomes concave from about the mid length of the array of bristles to the lower end of the bristle array, viewing FIG. 19. In this way the brush bristles may conform somewhat to the external shape of a tooth while at the same time the convex pattern of bristle tips, when viewed in the plane of FIG. 19, will accomplish good brushing action.

The fabrication and assembly of the dispensing brush 200 is believed to be readily understandable to those of ordinary skill in the art based on the foregoing description. The brush head and bristles of the embodiments of the dispensing brush described herein are advantageously dimensioned such that if the brush 1, or 30 or 200 is laid on its side on a generally horizontal flat surface the diameter of the handle 5, 66 or 202 is such that the brush may roll along such surface without the bristles engaging the surface. This is an advantageous feature to prevent contamination of the bristles. Moreover, the frictional grip between the brush covers 8 or 104, and the respective actuator button covers is just sufficient to retain the brush covers on the brush body but are easily removable.

In a preferred method of assembly of brush 200 the adapter 222, the actuator 230 and the rest of the upper brush assembly comprising the cover 55, the brush head 56a, feed tube 228 and the check valve 220 is connected to the handle 202 via the adapter 202 and with the check valve resting on its seat 216a. A charge of toothpaste may then be pumped into the chamber 212 through the opposite open end of the handle 202 to completely fill the chamber and at least the chambers 90a and 90b of plunger 90. Piston 206 is then placed in chamber 212 and any air trapped between the piston and the paste in the chamber is evacuated through the port 207 in the piston once the piston is placed in bore 204. After air is evacuated from the chamber 212, the port 207 is closed by inserting the pin part 210 of the closure disk 208 in the port 207. Locking engagement between handle 202 and adapter 222 may be provided by a small projection 222g, FIG. 19, which projects into a hole 202d, FIG. 20, formed in the upper wall 202a, as shown. Alternatively, the adapter 222 may be threadedly connected to the handle 202 by suitable threads, not shown, formed on the cylindrical depending wall part 222a and the upper cylindrical wall part 202a, respectively. A floss dispenser 11 or 32, or a suitable cover, not shown, may be connected to handle 202 to close bore 204.

From the foregoing it may be seen that this invention is well adapted to attain all of the ends and objectives hereinabove set forth, together with other advantages which are inherent to the apparatus. Although preferred embodiments of the invention have been described in detail hereinabove, those skilled in the art will also recognize that various substitutions and modifications may be made without departing from the scope and spirit of the appended claims.

1. A paste dispensing toothbrush comprising:
a brush head including brush bristles supported thereon and an orifice disposed in said brush head generally adjacent said bristles;
an elongated neck portion affixed to said brush head, said neck portion including an elongated passage therein in communication with said orifice;
an elongated handle including a paste reservoir chamber formed therein, said handle being connected to said brush head and neck by an adapter part;
an actuator including an actuator button operable for dispensing paste from said reservoir chamber through said orifice; and
a resilient plunger including a chamber formed therein operable to be in communication with said reservoir chamber and responsive to movement of said actuator to discharge a quantity of toothpaste for flow through said orifice onto said bristles.

2. The dispensing brush set forth in claim 1 including:
an elongated feed tube disposed in said passage in said neck portion and in paste receiving communication with said chamber in said plunger for conveying paste to said orifice in response to actuation of said actuator and said plunger.

3. The dispensing brush set forth in claim 2 wherein:
said passage in said neck portion extends beyond said orifice and is delimited by an end wall, and said feed tube includes a distal end extending toward said end wall sufficient to close off communication between said orifice and said passage.

4. The dispensing brush set forth in claim 1 including:
a check valve disposed in a passage between said reservoir chamber and said chamber in said plunger for preventing backflow of paste from said plunger to said reservoir chamber.

5. The dispensing brush set forth in claim 1 including:
a piston disposed in said reservoir chamber and movable to advance paste toward said plunger in response to actuation of said plunger to dispense a quantity of paste through said orifice.

6. The dispensing brush set forth in claim 5 wherein:
said piston includes an air evacuation port formed therein and a cover for closing said evacuation port to prevent flow of paste therefrom after evacuation of air from said reservoir chamber.

7. The dispensing brush set forth in claim 6 including:
a cleat supported on said piston and engageable with a bore wall of said reservoir chamber for preventing movement of said piston away from said plunger while allowing movement of said piston toward said plunger as paste is evacuated from said reservoir chamber.

8. The dispensing brush set forth in claim 1 including:
a dental floss dispenser assembly mounted on said handle at an end of said handle opposite an end which is connected to said brush head.

9. The dispensing brush set forth in claim 1 including:
a generally tubular shaped cover for said brush head and said neck portion, said cover including at least one vent port formed therein for allowing air to circulate through the interior of said cover to dry said bristles.

10. The dispensing brush set forth in claim 9 wherein:
said cover includes plural vent ports disposed generally opposite each other to allow crossflow ventilation through said cover for drying said bristles.

11. The dispensing brush set forth in claim 9 wherein:
said cover is formed of a transparent polymer material.

12. The dispensing brush set forth in claim 9 including:
a flexible membrane cover disposed over an actuator button for said actuator and disposed on said brush in a position to be frictionally engaged with said cover for retaining said cover in a position covering said brush head and said bristles.

13. The dispensing brush set forth in claim 1 including:
a return spring engageable with said actuator for urging said actuator to a position for receiving paste in said chamber in said plunger.

14. The dispensing brush set forth in claim 1 wherein:
said plunger is formed of a resilient material having an elastic memory for urging said plunger to a position to maximize the volume of said chamber in said plunger for receiving paste from said reservoir chamber.

15. The dispensing brush set forth in claim 14 wherein:
said plunger comprises a generally cylindrical tubular member including an enlarged diameter portion engageable with said actuator and a reduced diameter portion adapted to be in communication with said reservoir chamber and supported on a projection formed on one of said adapter and said handle, said enlarged diameter portion is operable to be at least partially telescoped over said reduced diameter portion in response to actuation of said actuator to reduce the volume of said chamber in said plunger.

16. The dispensing brush set forth in claim 15 including:
plural spaced apart seal ribs formed on said enlarged diameter portion and said reduced diameter portion of said plunger.

17. The dispensing brush set forth in claim 1 wherein:
the diameter of said handle is such that said dispensing brush may be placed on a flat surface and rolled therealong without said bristles engaging said surface to prevent contamination of said bristles.

18. The dispensing brush set forth in claim 1 wherein:
said adapter is integrally formed with said neck portion of said brush.

19. The dispensing brush set forth in claim 1 wherein:
said handle comprises a tubular member, at least a part of which is one of transparent and translucent for viewing the quantity of paste disposed in said reservoir chamber.

20. The dispensing brush set forth in claim 19 wherein:
said handle includes indicia formed thereon or on a cover disposed over said handle to provide an indication of the quantity of paste in said reservoir chamber.

21. The dispensing brush set forth in claim 1 wherein:
said brush bristles are arranged in a pattern of reduced height, progressively from a distal end of said brush head to provide a profile which may be one of concave and convex.
